(19) United States
(12) Patent Application Publication
(10) Pub. No.: US 2026/0211512 A1
(43) Pub. Date: Jul. 23, 2026

(54) MOUSE

(71) Applicant: DEXIN CORPORATION, New Taipei City (TW)

(72) Inventors: HO-LUNG LU, NEW TAIPEI CITY (TW); JO-NAN LO, New Taipei City (TW); San-Ching Chiang, New Taipei City (TW); Yi-Chen Liu, New Taipei City (TW)

(21) Appl. No.: 19/303,372

(22) Filed: Aug. 19, 2025

Related U.S. Application Data
(60) Provisional application No. 63/747,892, filed on Jan. 22, 2025.

(30) Foreign Application Priority Data
May 9, 2025 (TW) 114117420

(51) Int. Cl. G06F 3/0354

(52) U.S. Cl. CPC G06F 3/03543

(57) ABSTRACT

A mouse includes a housing, an auxiliary button disposed on the housing, a switch module, and a bottom base. An inner side of the auxiliary button includes a pressing structure. The switch module includes a supporting structure disposed on an inner side of the housing, an adjusting assembly, a bottom plate connected to the supporting structure, and a micro switch disposed on the bottom plate. The adjusting assembly includes an operating component movably connected to the supporting structure. A switch component of the micro switch faces toward the pressing structure. The operating component is movable relative to the supporting structure and drives the bottom plate by being manipulated to change a spacing between the switch component and the pressing structure. The bottom base is configured to carry a main circuit board, a motion detection module, and a processor disposed thereon.

### CROSS-REFERENCE TO RELATED PATENT APPLICATION

This application claims the benefit of priority to Taiwan Patent Application No. 114117420, filed on May 9, 2025. The entire content of the above identified application is incorporated herein by reference.

This application claims the benefit of priority to the U.S. Provisional Patent Application Ser. No. 63/747892, filed on January 22, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a mouse, and more particularly to a mouse including a side button.

### BACKGROUND OF THE DISCLOSURE

One of the problems with a conventional mouse having a side button is that a tactile feedback of the side button cannot be adjusted according to requirements of the user, which causes trouble for users with special needs.

### SUMMARY OF THE DISCLOSURE

In response to the above-referenced technical inadequacy, the present disclosure provides a mouse for improving on the conventional mouse including a side button and addressing the problem that a tactile feedback of the side button cannot be adjusted.

In order to solve the above-mentioned problems, one of the technical aspects adopted by the present disclosure is to provide a mouse. The mouse includes a housing, at least one auxiliary button, at least one switch module, and a bottom base. The at least one auxiliary button is movably disposed on one side of the housing, and an inner side of the at least one auxiliary button includes a pressing structure. The at least one switch module includes a supporting structure, at least one adjusting assembly, a bottom plate, and at least one micro switch. The supporting structure is fixed to an inner side of the housing, the at least one adjusting assembly includes an operating component, and the operating component is movably connected to the supporting structure. The bottom plate is connected to the supporting structure. The at least one micro switch is disposed on the bottom plate, and a switch component of the at least one micro switch faces toward the pressing structure. The operating component is movable relative to the supporting structure and drives the bottom plate by being manipulated, so as to change a spacing between the switch component and the pressing structure. The bottom base is configured to carry a main circuit board, a motion detection module, and a processor disposed thereon, the bottom plate is a component that is independent from the main circuit board, and the at least one micro switch is electrically coupled to the processor through a flexible flat cable or a wire.

Therefore, in the mouse provided by the present disclosure, through a design of the switch modules including the supporting structure, the two adjusting assemblies, the bottom plate, and the two micro switches, the assembler can adjust the spacing between the switch component and the pressing structure by manipulating the operating component to change a tactile feedback of each of the two auxiliary buttons when pressed.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a mouse according to a first embodiment of the present disclosure;

FIG. 2 is a schematic exploded view of the mouse according to the first embodiment of the present disclosure;

FIG. 3 is a partial schematic cross-sectional view of the mouse according to the first embodiment of the present disclosure;

FIG. 4 is a partial schematic exploded view of FIG. 3;

FIG. 5 and FIG. 6 are partial schematic exploded views of the switch module of the mouse from different angles of view according to the first embodiment of the present disclosure;

FIG. 7 is a schematic cross-sectional view taken along line VII-VII of FIG. 3;

FIG. 8 is a partial schematic cross-sectional view of a mouse according to a second embodiment of the present disclosure;

FIG. 9 is a partial schematic exploded view of the mouse according to the second embodiment of the present disclosure;

FIG. 10 is a partial schematic exploded view of a switch module of the mouse according to the second embodiment of the present disclosure;

FIG. 11 is a partial schematic exploded view of the switch module of the mouse according to the second embodiment of the present disclosure;

FIG. 12 is a partial schematic top view of the mouse according to the second embodiment of the present disclosure;

FIG. 13 is a partial schematic cross-sectional view of a mouse according to a third embodiment of the present disclosure;

FIG. 14 is a partial schematic exploded view of the mouse according to the third embodiment of the present disclosure;

FIG. 15 is a schematic view of a switch module of the mouse according to the third embodiment of the present disclosure;

FIG. 16 is a partial schematic exploded view of the switch module of the mouse according to the third embodiment of the present disclosure;

FIG. 17 is a partial schematic cross-sectional view of the switch module of the mouse according to the third embodiment of the present disclosure;

FIG. 18 is a schematic cross-sectional view taken along line XVIII- XVIII of FIG. 13;

FIG. 19 is a partial schematic cross-sectional view of a mouse according to a fourth embodiment of the present disclosure;

FIG. 20 is a partial schematic exploded view of the mouse according to the fourth embodiment of the present disclosure;

FIG. 21 is a partial schematic exploded view of a switch module of the mouse according to the fourth embodiment of the present disclosure;

FIG. 22 is a partial schematic cross-sectional view of the mouse according to the fourth embodiment of the present disclosure; and

FIG. 23 is a schematic cross-sectional view taken along line XXIII-XXIII of FIG. 19.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [First Embodiment]

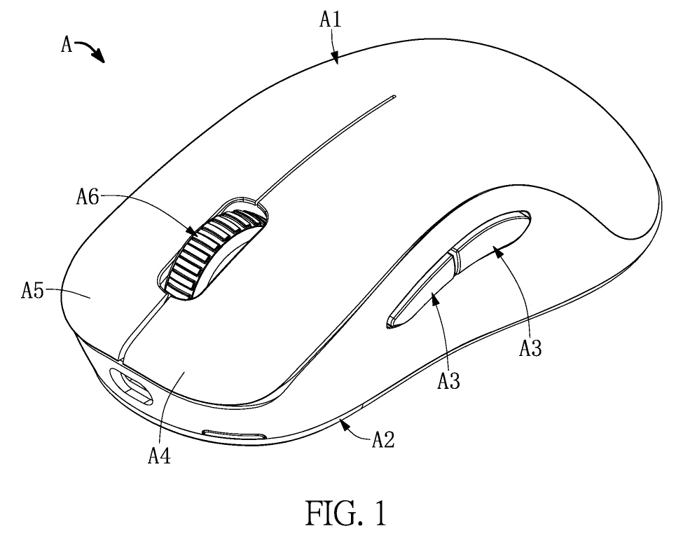

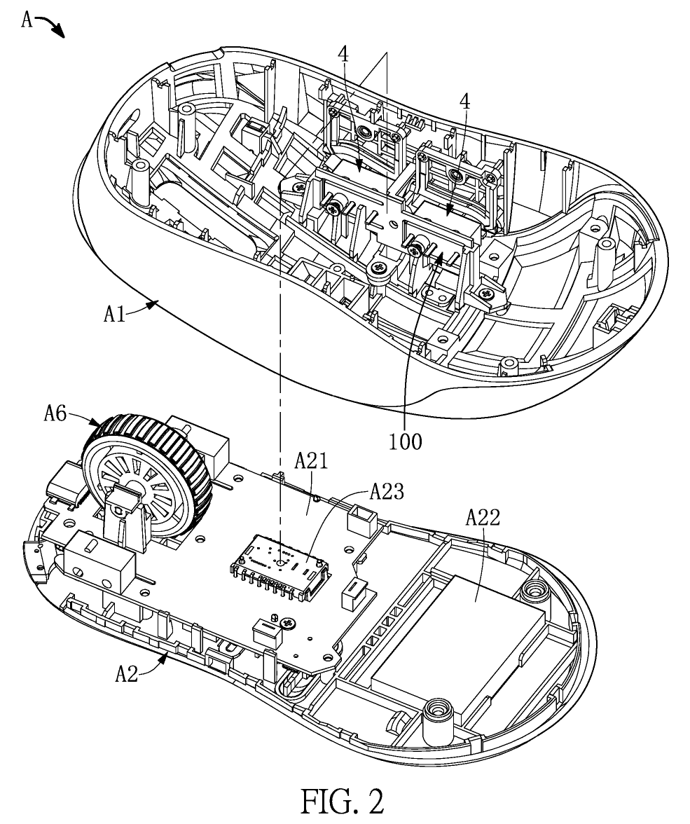

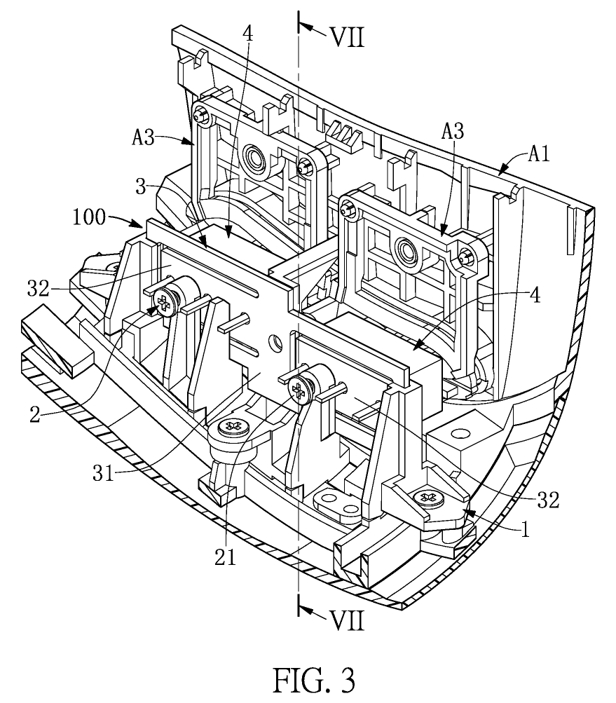

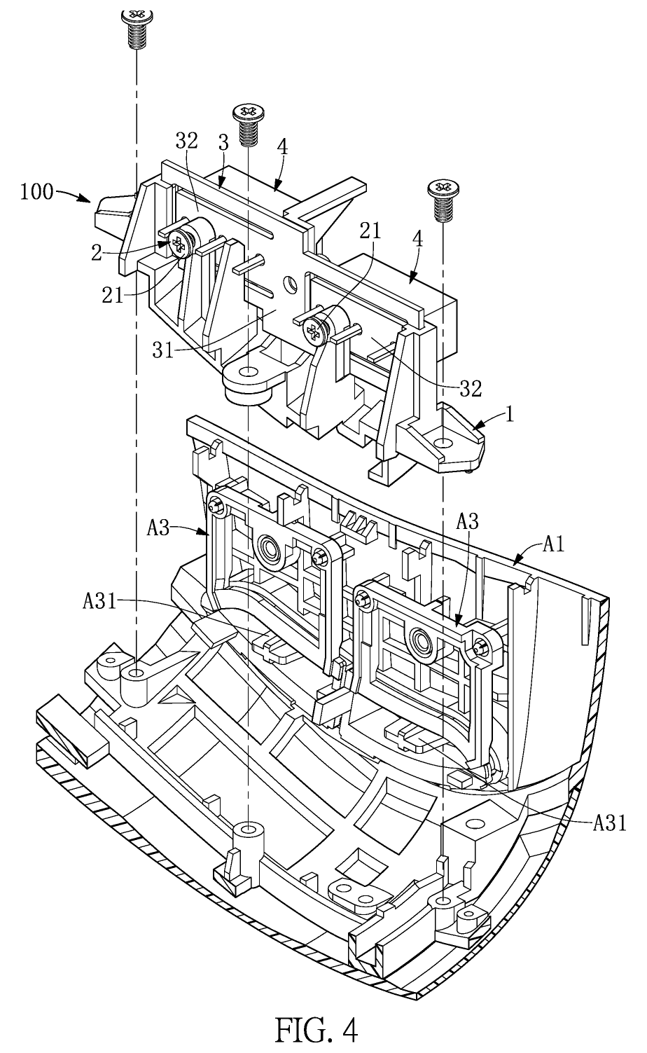

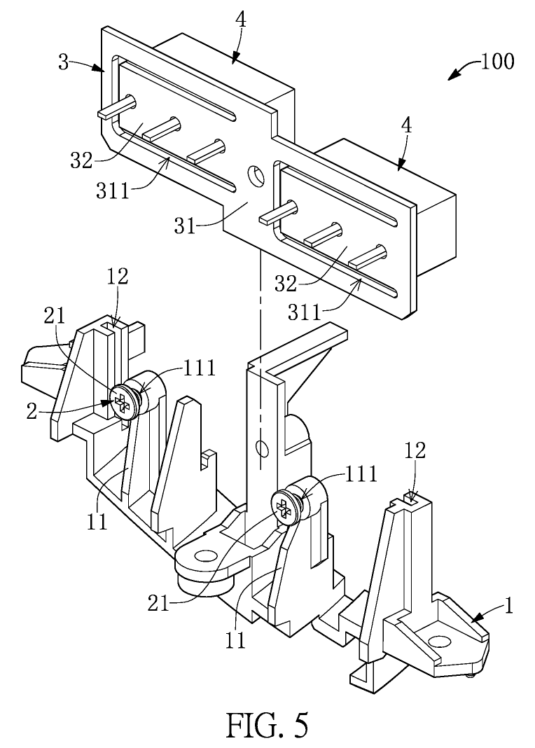

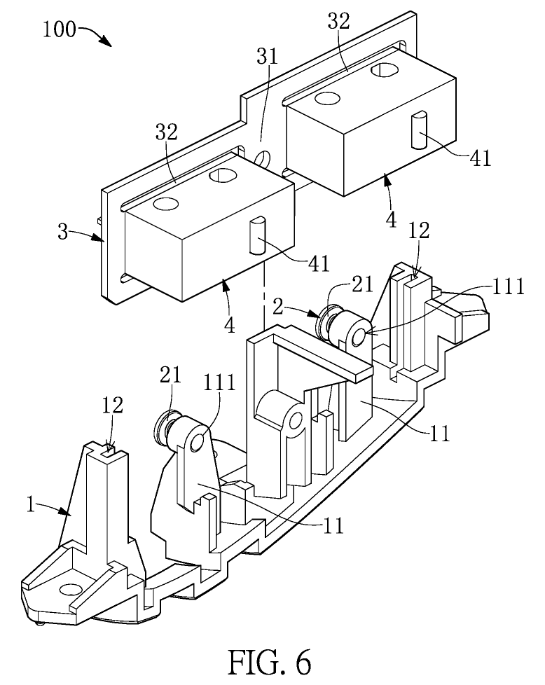

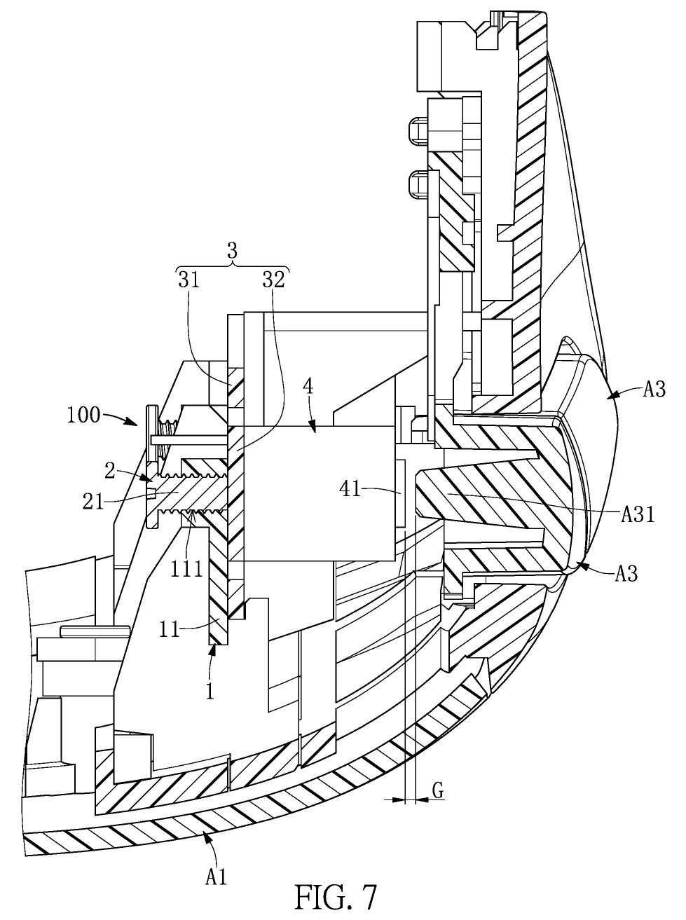

Referring to FIG. 1 to FIG. 4, FIG. 1 is a schematic view of a mouse according to a first embodiment of the present disclosure, FIG. 2 is a schematic exploded view of the mouse according to the first embodiment of the present disclosure, FIG. 3 is a partial schematic cross-sectional view of the mouse according to the first embodiment of the present disclosure, FIG. 4 is a partial schematic exploded view of FIG. 3, FIG. 5 and FIG. 6 are partial schematic exploded views of the switch module of the mouse from different angles of view according to the first embodiment of the present disclosure, and FIG. 7 is a schematic cross-sectional view taken along line VII-VII of FIG. 3.

The present disclosure provides a mouse A including a housing A1, a bottom base A2, two auxiliary buttons A3, a left button A4, a right button A5, a scroll wheel A6, and a switch module 100. It should be noted that each of the two auxiliary buttons A3 referred to herein is a button different from the left button A4 and the right button A5. For example, each of the two auxiliary buttons A3 can be a side button arranged at a left side or a right side of the mouse A, but a position of each of the two auxiliary buttons A3 specifically disposed can be adjusted according to practical requirements.

In the drawings of the present embodiment, the mouse A is provided with two auxiliary buttons A3 as an example, but a quantity of the auxiliary button A3 of the mouse A is not limited to two. In different embodiments, the quantity of the auxiliary button A3 of the mouse A can be one or more than three.

The housing A1 is detachably installed on one side of the bottom base A2. The two auxiliary buttons A3, the left button A4, and the right button A5 are movably disposed on the housing A1. The bottom base A2 is configured to carry a main circuit board A21, a motion detection module A22, and a processor A23 disposed thereon, the bottom plate 3 is a component that is independent from the main circuit board A21, and each of two micro switches 4 is electrically coupled to the processor A23 through a flexible flat cable or a wire. Electronic components of the bottom base A2 are part of the conventional technology and will not be described in detail herein.

The switch module 100 is detachably installed in an inner portion of the housing A1. Specifically, when the housing A1 is separated from the bottom base A2, the switch module 100 is fixed to the inner portion of the housing A. That is, the switch module 100 is not installed on the main circuit board A21 of the bottom base A2. Accordingly, the switch module 100 can be easily installed, disassembled, and manipulated by an assembler.

As shown in FIG. 1 and FIG. 2, the two auxiliary buttons A3 are movably disposed on one side of the housing A1, an inner side of each of the two auxiliary buttons A3 includes a pressing structure A31. When each of the two auxiliary buttons A3 is pressed by the user, the pressing structure A31 of the inner side of one of the two auxiliary buttons A3 pushes a switch component 41 (as shown in FIG. 6 and FIG. 7) of a corresponding one of the two micro switches 4 of the switch module 100.

As shown in FIG. 3 to FIG. 7, the switch module 100 includes a supporting structure 1, two adjusting assemblies 2, a bottom plate 3, and the two micro switches 4. It should be noted that a quantity of the adjusting assembly 2 and a quantity of the micro switch 4 of the switch module 100 correspond to the quantity of the auxiliary button A3. That is, in one embodiment, when the mouse A includes only a single auxiliary button A3, the switch module 100 includes only a single adjusting assembly 2 and a single micro switch 4.

The supporting structure 1 is fixed to an inner side of the housing A1. For example, the supporting structure 1 is fixed to the inner side of the housing A1 through the supporting structure 1. An overall structure of the switch module 100 is mainly fixed to the inner side of the housing A1 through the supporting structure 1.

As shown in FIG. 5 and FIG. 6, each of the two adjusting assemblies 2 includes an operating component 21. The operating component 21 is movably connected to the supporting structure 1. For example, the operating component 21 of each of the two adjusting assemblies 2 can be a screw, the supporting structure 1 can have two supporting arms 11, an end of each of the two supporting arms 11 has a locking hole 111, and the screw (i.e., the operating component 21) is locked into the locking hole 111 of a corresponding one of the two supporting arms 11.

The bottom plate 3 is installed on the supporting structure 1. In practice, for example, the supporting structure 1 can include two inserting slots 12, and two sides of the bottom plate 3 are respectively arranged in the two inserting slots 12. The switch module 100 is installed on the bottom plate 3, and the bottom plate 3 is a circuit board. Specifically, the bottom plate 3 includes a body 31 and two elastic plate bodies 32, the body 31 has two penetrating holes 311, one end of each of the two elastic plate bodies 32 is formed by extending from an inner side of one of the two penetrating holes 311 (i.e., one end of each of the two elastic plate bodies 32 is connected to the inner side of one of the two penetrating holes 311), another end of each of the two elastic plate bodies 32 is a free end, and each of the two elastic plate bodies 32 can be pushed to elastically deform relative to the body 31.

Two sides of the body 31 are respectively arranged in the two inserting slots 12, and the body 31 can be fixed to the supporting structure 1 through the screw. The two micro switches 4 are respectively fixed to the two elastic plate bodies 32, and the switch component 41 of each of the two micro switches 4 faces toward the pressing structure A31 (as shown in FIG. 6 and FIG. 7).

As shown in FIG. 3, and FIG. 5 to FIG. 7, the operating component 21 and a corresponding one of the two micro switches 4 are arranged at opposite sides of one of the two elastic plate bodies 32. When the assembler manipulates the operating component 21 (i.e., screw) to enable an end of the operating component 21 to push one of the two elastic plate bodies 32 adjacent thereto, the one of the two elastic plate bodies 32 drives a corresponding one of the two micro switches 4 to move toward the pressing structure A31 of one of the two auxiliary buttons A3 adjacent thereto. Accordingly, a spacing G between the pressing structure A31 and the switch component 41 can be reduced, thereby changing a tactile feedback of each of the two auxiliary buttons A3 for being pressed by the user.

It should be noted that, when the end of the operating component 21 pushes one of the two elastic plate bodies 32, the one of the two elastic plate bodies 32 is elastically deformed. Specifically, when the assembler moves the screw (i.e., the operating component 21) in a direction away from one of the two elastic plate bodies 32, the one of the two elastic plate bodies 32 moves in a direction away from the pressing structure A31 by an elastic restoring force thereof, so that the spacing G between the switch component 41 of a corresponding one of the two micro switches 4 and the pressing structure A31 is correspondingly increased.

Based on the above, the assembler can change the spacing G between the switch component 41 and the pressing structure A31 by adjusting the operating component 21 according to practical requirements, so that each of the mice A manufactured by a factory can have an approximately same spacing G. That is, when the consumer purchases the mice A of a same model, the two auxiliary buttons A3 of each of the mice A may have an approximately same tactile feedback when pressed. Naturally, in practice, after the consumer purchases the mouse A, the consumer can disassemble the mouse A and adjust the spacing A by adjusting the operating component 21.

In the relevant art, the spacing between the switch component and the pressing structure of each of various types of mice cannot be adjusted. Accordingly, when the consumer purchases two mice of a same model, two of the auxiliary buttons respectively provided by the two mice arranged at a same position usually provide different tactile feedback, so as to cause a trouble for the consumer, especially for gamers and consumers having a high requirement for the tactile feedback.

It should be noted that, in the drawings of the present embodiment, the mouse A is provided with the two auxiliary buttons A3, and the switch module 100 is provided with the two micro switches 4 and the two elastic plate bodies 32, but the present disclosure is not limited thereto. In different embodiments, the mouse A can include only a single auxiliary button A3, and the switch component 100 can include only a single micro switch 4. In one embodiment, the mouse A can include four auxiliary buttons A3, two of the four auxiliary buttons A3 are arranged at a left side of the mouse A, and another two of the four auxiliary buttons A3 are arranged at a right side of the mouse A. Moreover, the mouse A can include two switch modules 100, each of the two switch modules 100 can have two micro switches 4 and two elastic plate bodies 32.

### [Second Embodiment]

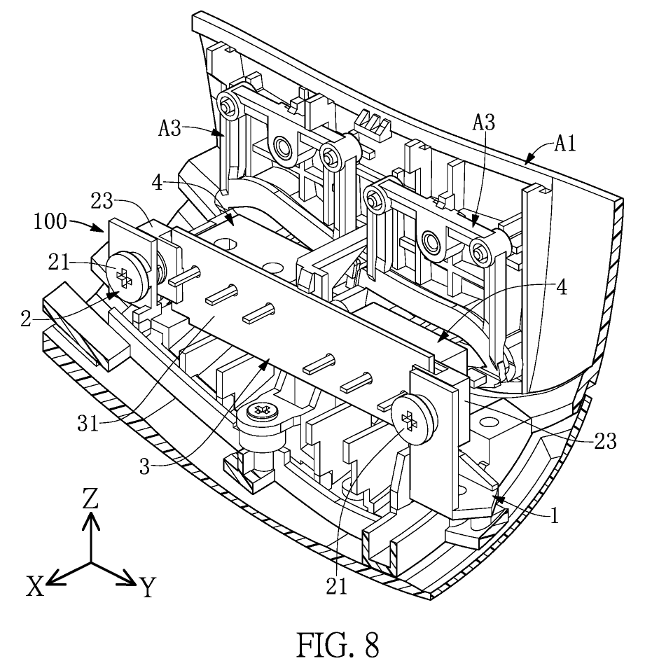

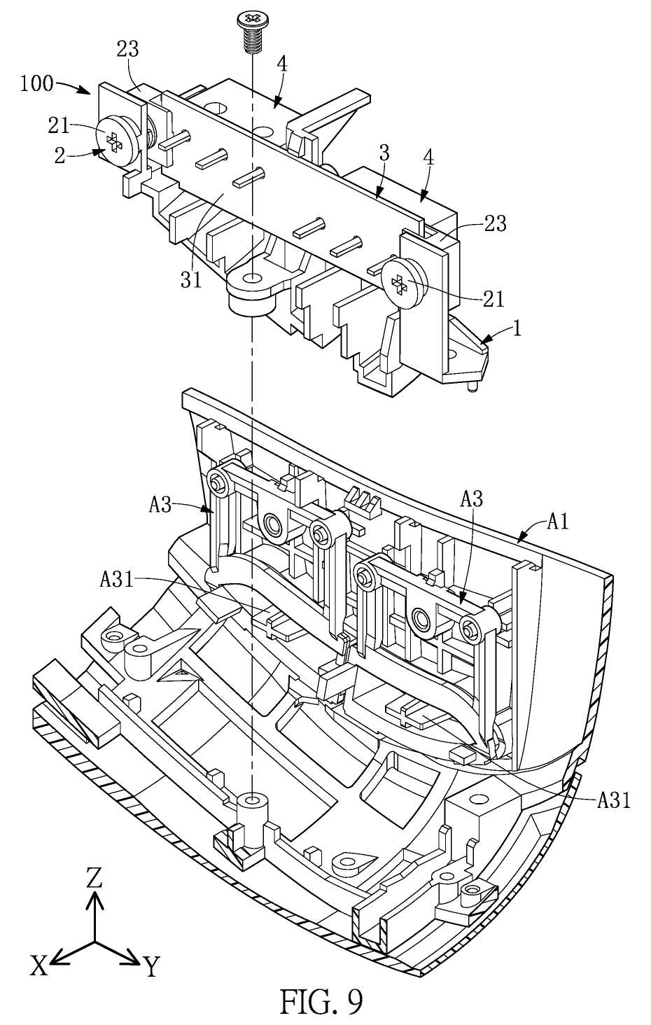

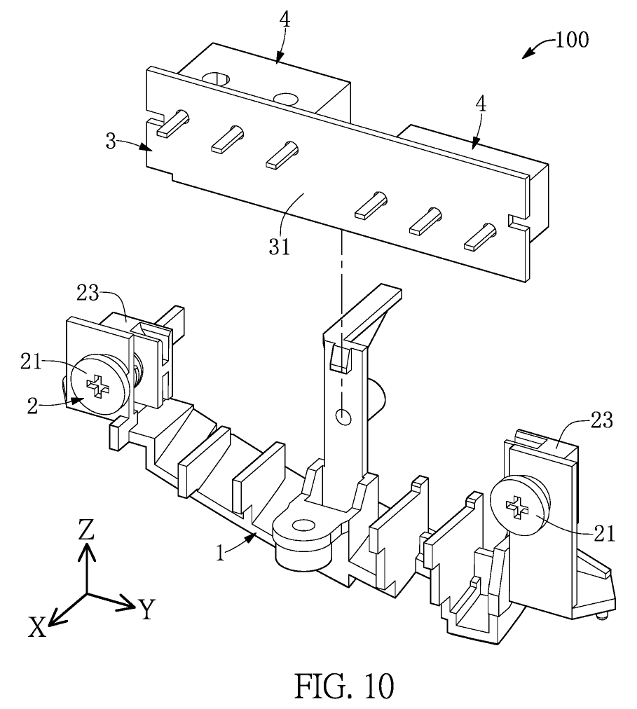

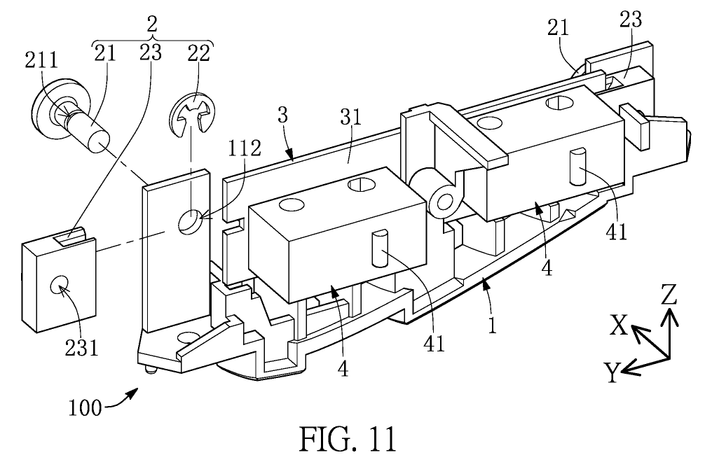

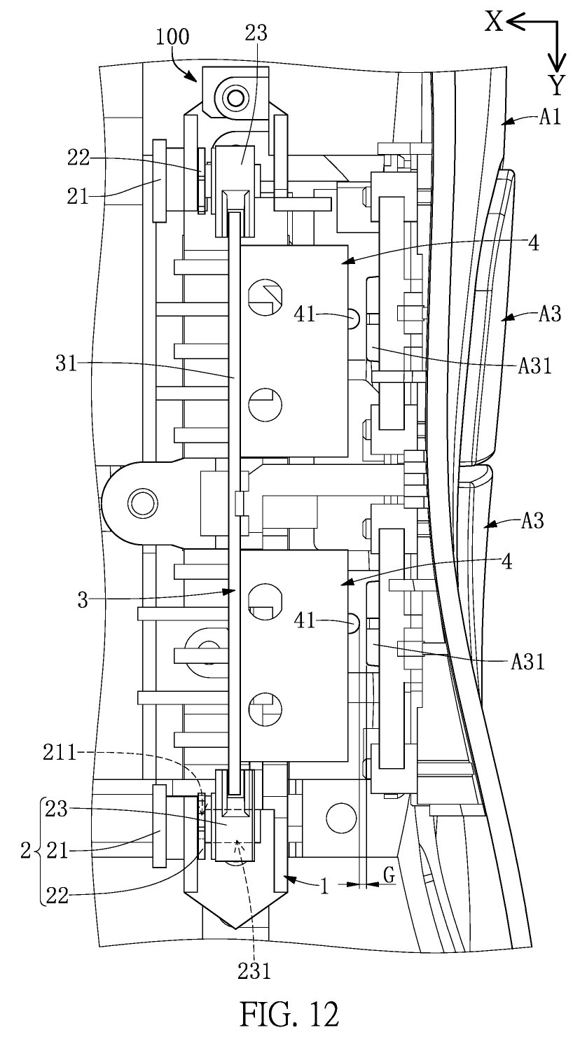

Referring to FIG. 8 to FIG. 12, FIG. 8 is a partial schematic cross-sectional view of a mouse according to a second embodiment of the present disclosure, FIG. 9 is a partial schematic exploded view of the mouse according to the second embodiment of the present disclosure, FIG. 10 is a partial schematic exploded view of a switch module of the mouse according to the second embodiment of the present disclosure, FIG. 11 is a partial schematic exploded view of the switch module of the mouse according to the second embodiment of the present disclosure, and FIG. 12 is a partial schematic top view of the mouse according to the second embodiment of the present disclosure.

It should be noted that only differences between the second embodiment and the aforementioned embodiment are described below, and the parts not described herein are the same as the aforementioned embodiment.

In the present embodiment, a switch module 100 includes a supporting structure 1, two adjusting assemblies 2, a bottom plate 3, and two micro switches 4. A quantity of the adjusting assembly 3 and a quantity of the micro switch 4 of the switch module 100 provided by the present embodiment correspond to a quantity of the auxiliary button A3 of the mouse A. That is, in one variation of the present embodiment, when the mouse A includes only a single auxiliary button A3, the switch module 100 includes only a single adjusting assembly 2 and a single micro switch 4.

In the present embodiment, the bottom plate 3 is not provided with the elastic plate body 32 of the aforementioned embodiment, and the bottom plate 3 only includes a body 31. Two action components 23 are respectively fixed to two sides of the bottom plate 3, and a manner of fixing each of the two action components 2 and the bottom plate 3 is not limited herein.

The two micro switches 4 are fixed to one side surface of the bottom plate 3, a position of the bottom plate 3 between the two micro switches 4 can be fixed to the supporting structures 1 through a fixing component (e.g., a screw), and two ends of the bottom plate 3 that are respectively provided with the two action components 23 can be slightly and elastically deformed through a movement of the two action components 23.

The operating component 21 of each of the adjusting assemblies 2 is a screw, and each of the adjusting assemblies 2 further includes a limiting component 22 and an action component 23. One part of the screw (i.e., the operating component 21) passes through a through hole 112 of the supporting structure 1, and the through hole 112 can be, for example, a penetrating hole or a locking hole. The limiting component 22 is connected to the screw (i.e., the operating component 21), and the limiting component 22 is configured to prevent the screw (i.e., the operating component 21) from moving along an axis direction relative to the supporting structure 1. Specifically, the limiting component 22 can be a C-shaped fastener, and the C-shaped fastener is fixed (e.g., engaged) in an annular groove 211 of the screw (i.e., the operating component 21). Accordingly, when the screw (i.e., the operating component 21) is rotated, the screw (i.e., the operating component 21) only rotates and does not move forward or backward along the axis direction relative to the supporting structure 1. That is, the screw (i.e., the operating component 21) becomes a component that is similar to a screw rod.

Each of the two action components 23 has a locking hole 231, and one end of the screw (i.e., the operating component 21) is locked in the locking hole 231 of a corresponding one of the two action components 23. When the screw (i.e., the operating component 21) is manipulated, the screw (i.e., the operating component 21) does not move forward or backward along the axis direction (e.g., an X-axis direction as shown in FIG. 8), but the screw (i.e., the operating component 21) rotates to drive a corresponding one of the two action components 23 to move forward along the axis direction (e.g., the X-axis direction as shown in FIG. 8).

As shown in FIG. 8 and FIG. 12, when one of the two action components 23 is driven to move in a direction toward the pressing structure A31 along the axis direction (e.g., the X-axis direction as shown in FIG. 8 and FIG. 12) by the screw (i.e., the operating component 21), the one of the two action components 23 drives one end of the bottom plate 3 connected thereto to move toward the pressing structure A31, thereby changing the spacing G between the switch component 41 of a corresponding one of the two micro switches 4 and the pressing structure A31. Moreover, when the screw (i.e., the operating component 21) drives the action component 23 to move toward the pressing structure A31, the bottom plate 3 is elastically deformed. Accordingly, when the assembler rotates the screw (i.e., operating component 21) in a reverse direction, the bottom plate 3 moves in a direction away from the pressing structure A31 by an elastic restoring force thereof.

Based on the above, the assembler can change the spacing G between each of the micro switches 4 and the pressing structure A31 adjacent thereto by manipulating the screw (i.e., the operating component 21).

### [Third Embodiment]

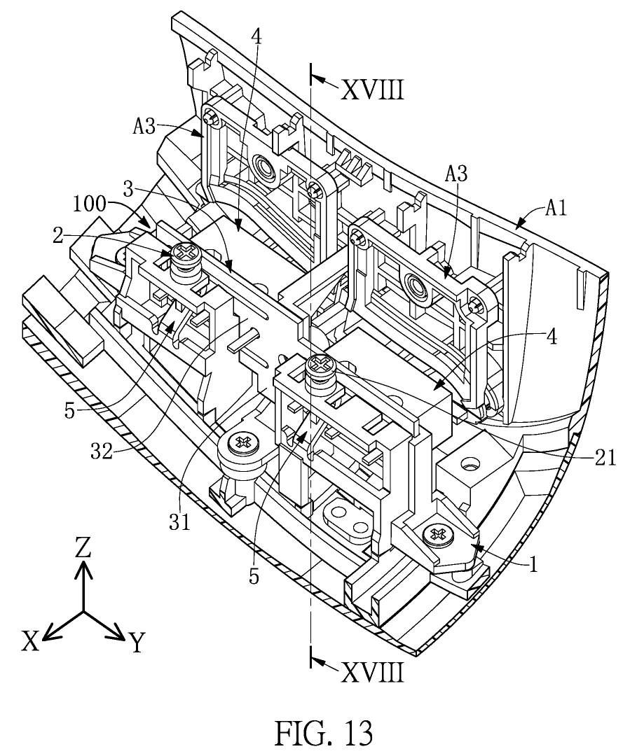

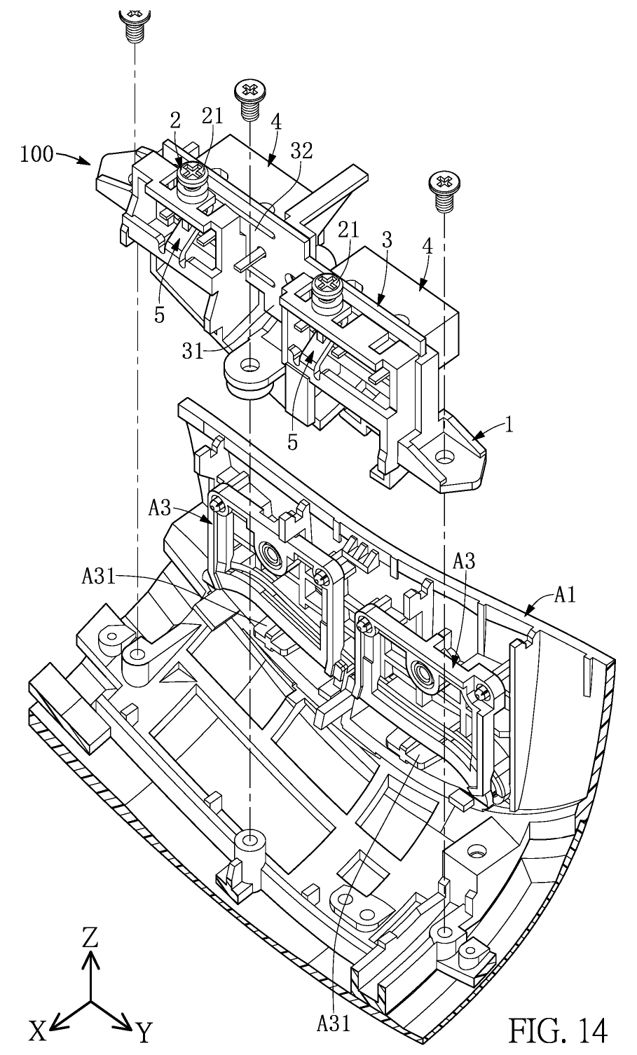

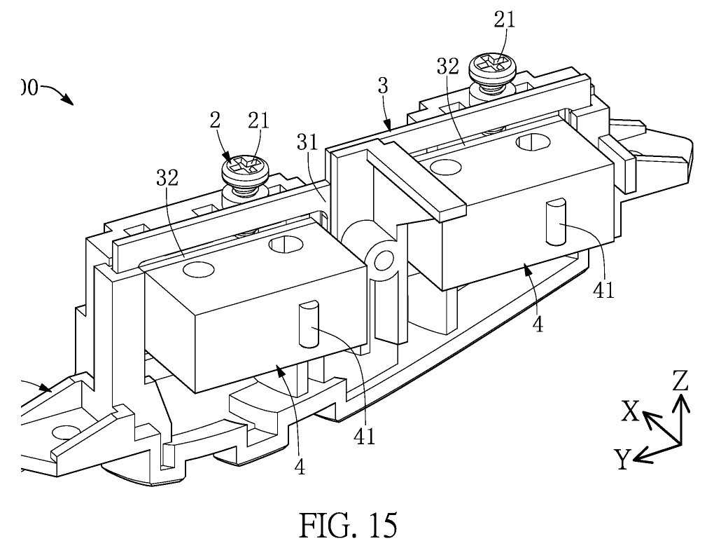

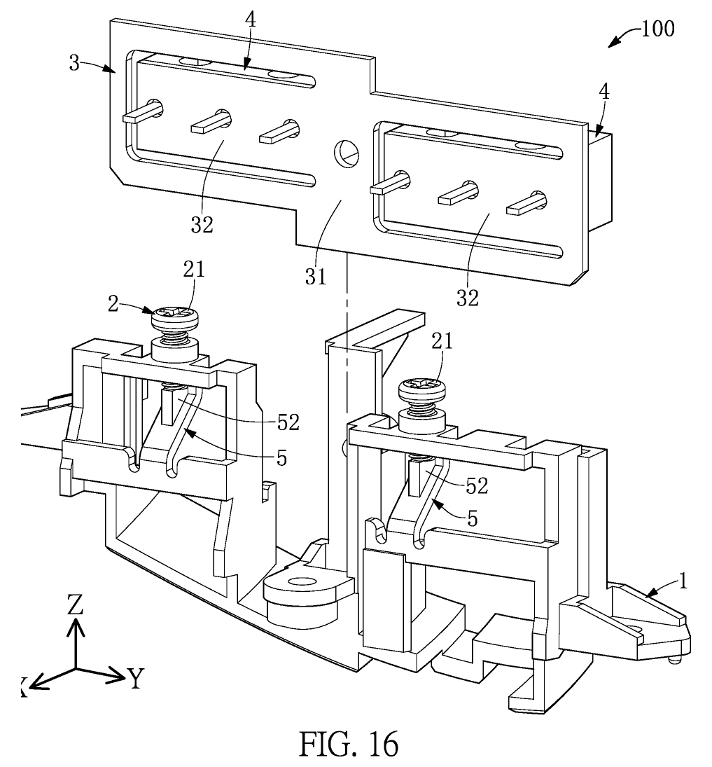

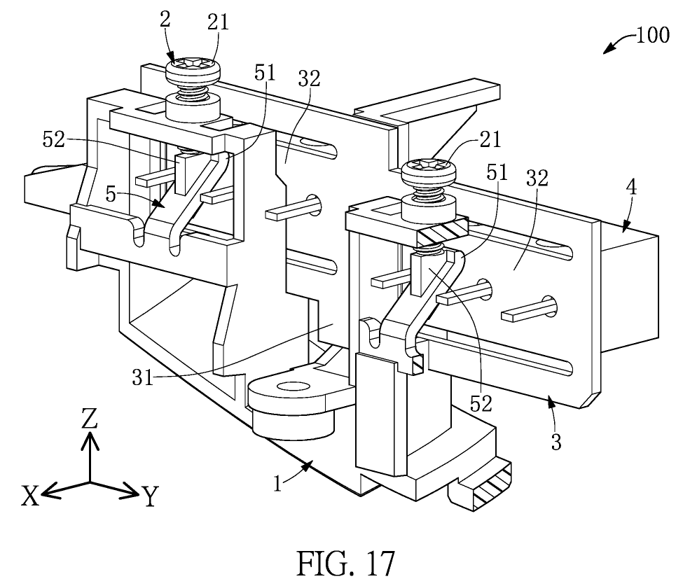

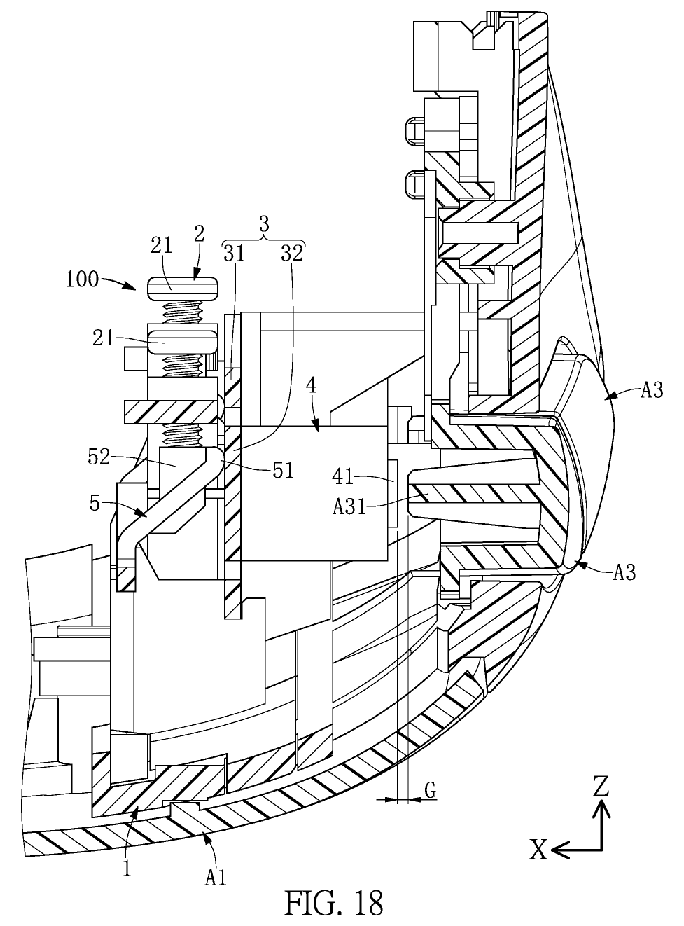

Referring to FIG. 13 to FIG. 18, FIG. 13 is a partial schematic cross-sectional view of a mouse according to a third embodiment of the present disclosure, FIG. 14 is a partial schematic exploded view of the mouse according to the third embodiment of the present disclosure, FIG. 15 is a schematic view of a switch module of the mouse according to the third embodiment of the present disclosure, FIG. 16 is a partial schematic exploded view of the switch module of the mouse according to the third embodiment of the present disclosure, FIG. 17 is a partial schematic cross-sectional view of the switch module of the mouse according to the third embodiment of the present disclosure, and FIG. 18 is a schematic cross-sectional view taken along line XVIII- XVIII of FIG. 13.

It should be noted that only differences between the second embodiment and the aforementioned embodiment are described below, and the parts not described herein are the same as the aforementioned embodiment.

In the present embodiment, a switch module 100 includes a supporting structure 1, two adjusting assemblies 2, a bottom plate 3, and two micro switches 4. A quantity of the adjusting assembly 3 and a quantity of the micro switch 4 of the switch module 100 provided by the present embodiment correspond to a quantity of the auxiliary button A3 of the mouse A. That is, in one variation of the present embodiment, when the mouse A includes only a single auxiliary button A3, the switch module 100 includes only a single adjusting assembly 2 and a single micro switch 4.

As shown in FIG. 16, it should be noted that the bottom plate 3 provided by the present embodiment is the same as the bottom plate 3 provided by the first embodiment, that is, the bottom plate 3 includes the body 31 and the two elastic plate bodies 32, and the two micro switches 4 are respectively disposed on the two elastic plate bodies 32.

In the present embodiment, the switch module 100 further includes two elastic arms 5, one end of each of the two elastic arms 5 is connected to the supporting structure 1, another end of each of the two elastic arms 5 is a free end. Specifically, when each of the two elastic arms 5 is pressed, the two elastic arms 5 can be elastically deformed. In practice, the two elastic arms 5 and the supporting structure 1 can be formed as a single one-piece structure. A quantity of the elastic arm 5 of the switch module 100 corresponds to the quantity of the auxiliary button A3.

Each of the two elastic arms 5 is obliquely disposed in a direction toward one of the two elastic plate bodies 32 of the bottom plate 3. The supporting structure 1 has two locking holes 111 (as shown in FIG. 5 and FIG. 6), each of the two locking holes 111 faces toward a free end 51 of one of the two elastic arms 5, and the operating component 21 of each of the two adjusting assemblies 2 is a screw. Specifically, an end of the screw (i.e., the operating component 21) is configured to press one of the two elastic arms 5 by manipulating the screw (i.e., the operating component 21) to enable the free end 51 of the one of the two elastic arms 5 to push one of the two elastic plate bodies 32 adjacent thereto, so that one of the two micro switches 4 disposed on the one of the two elastic plate bodies 32 is driven to move in a direction toward the pressing structure A31 adjacent thereto to change the spacing G (as shown in FIG. 18) between the switch component 41 of one of the two micro switches 4.

As shown in FIG. 16 to FIG. 18, in practice, each of the two elastic arms 5 includes an abutting portion 52, the abutting portion 52 faces toward one of the two locking holes 111 of the supporting structure 1, and the abutting portion 52 is configured to provide the end of the screw (i.e., the operating component 21) to push thereagainst. Specifically, through a design of the abutting portion 52, it can be ensured that the end of the screw (i.e., the operating component 21) consistently pushes against the free end 51 of one of the two elastic arms 5 when the screw (i.e., the operating component 21) is manipulated.

It should be noted that, as shown in FIG. 17 and FIG. 18, each of the two auxiliary buttons A3 is movable along a transverse direction (e.g., a negative X-axis direction as shown in FIG. 17 and FIG. 18) by being pressed, the screw (i.e., the operating component 21) is movable along a longitudinal direction (e.g., a Z-axis direction as shown in FIG. 17 and FIG. 18) relative to the supporting structure 1 by being manipulated, and the longitudinal direction is not parallel to the transverse direction. Based on the above, the screw (i.e., the operating component 21) can be easily manipulated by the assembler.

### [Fourth Embodiment]

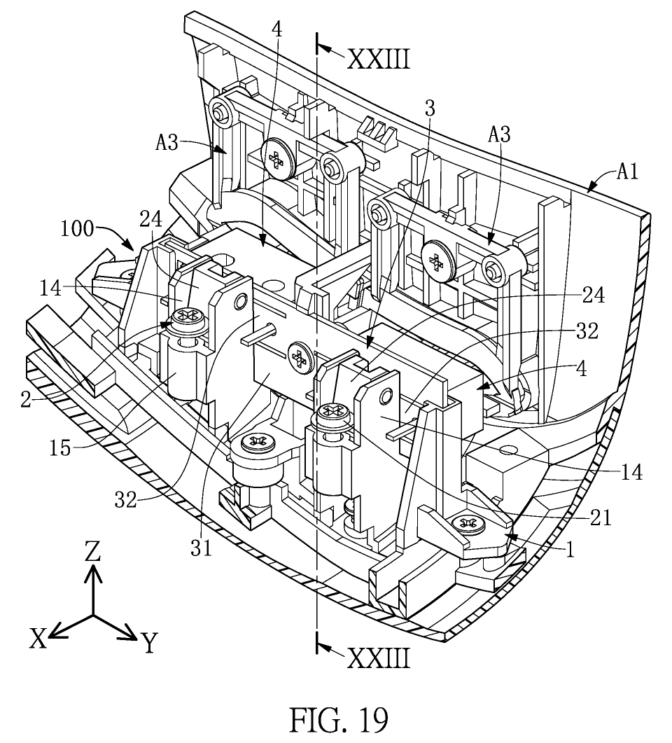

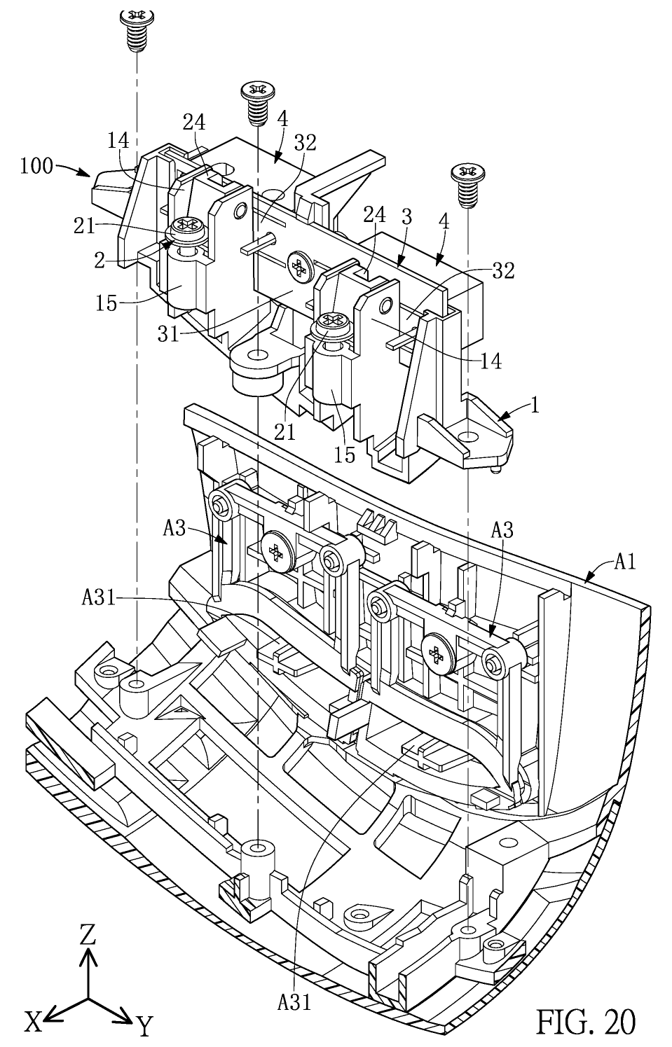

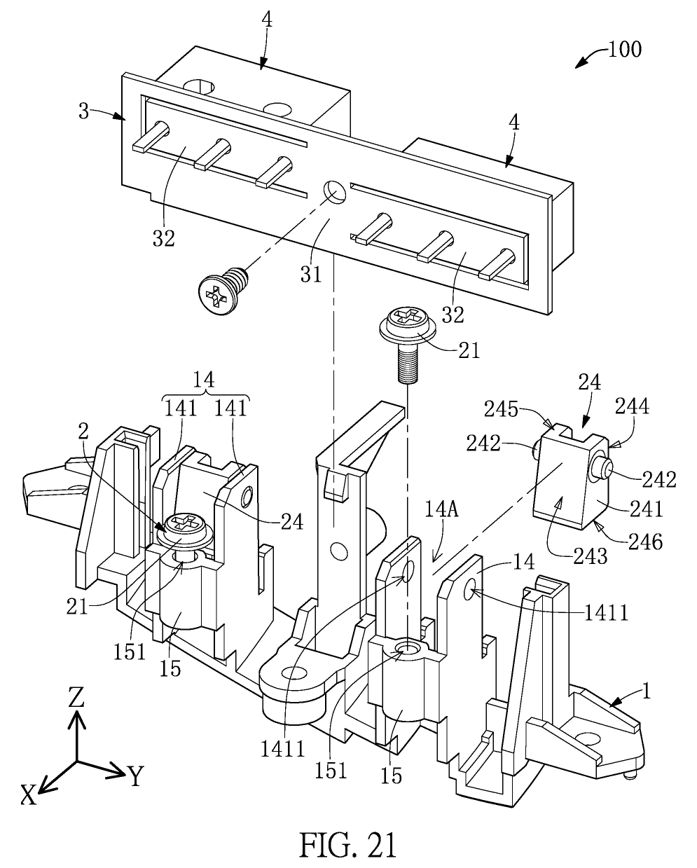

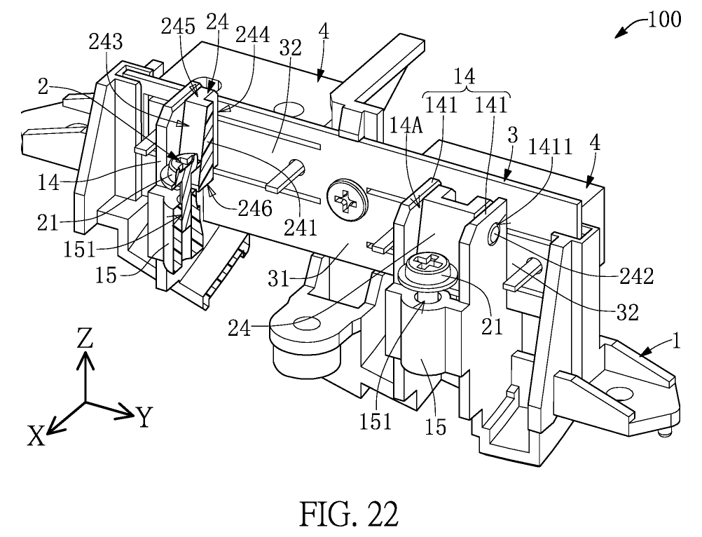

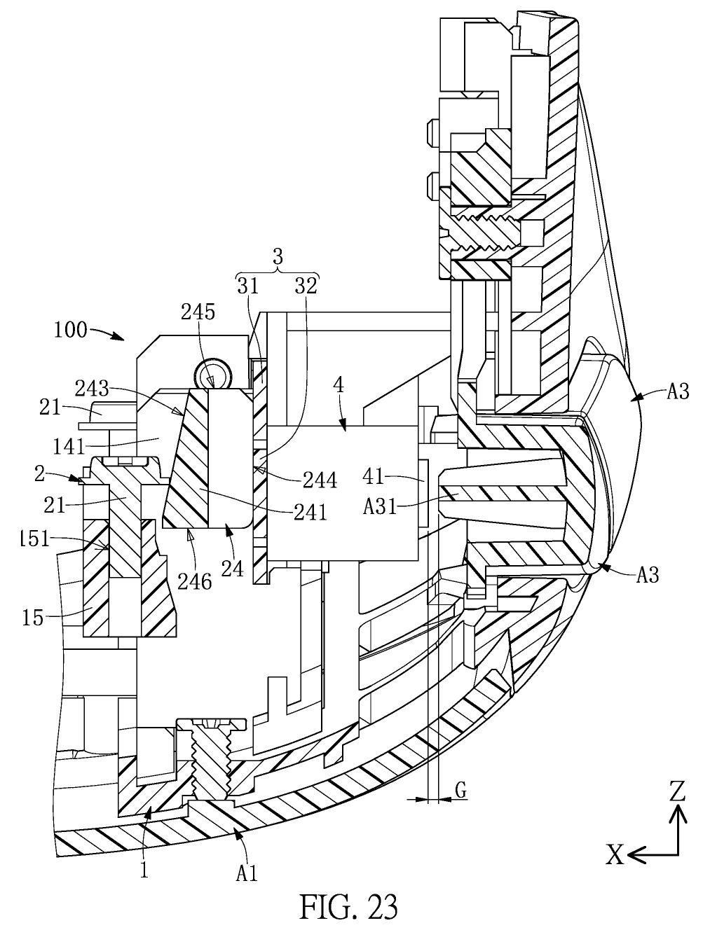

Referring to FIG. 19 to FIG. 23, FIG. 19 is a partial schematic cross-sectional view of a mouse according to a fourth embodiment of the present disclosure, FIG. 20 is a partial schematic exploded view of the mouse according to the fourth embodiment of the present disclosure, FIG. 21 is a partial schematic exploded view of a switch module of the mouse according to the fourth embodiment of the present disclosure, FIG. 22 is a partial schematic cross-sectional view of the mouse according to the fourth embodiment of the present disclosure, and FIG. 23 is a schematic cross-sectional view taken along line XXIII- XXIII of FIG. 19.

It should be noted that only differences between the second embodiment and the aforementioned embodiment are described below, and the parts not described herein are the same as the aforementioned embodiment.

In the present embodiment, a switch module 100 includes a supporting structure 1, two adjusting assemblies 2, a bottom plate 3, and two micro switches 4. A quantity of the adjusting assembly 3 and a quantity of the micro switch 4 of the switch module 100 provided by the present embodiment correspond to a quantity of the auxiliary button A3 of the mouse A. That is, in one variation of the present embodiment, when the mouse A includes only a single auxiliary button A3, the switch module 100 includes only a single adjusting assembly 2 and a single micro switch 4.

As shown in FIG. 21, it should be noted that the bottom plate 3 provided by the present embodiment is the same as the bottom plate 3 provided by the first embodiment, that is, the bottom plate 3 includes the body 31 and the two elastic plate bodies 32, and the two micro switches 4 are respectively disposed on the two elastic plate bodies 32.

The switch module 100 further includes two auxiliary brackets 14 and two longitudinal structures 15, each of the two auxiliary brackets 14 has two side walls 141, the two side walls 141 face toward each other and are spaced apart from each other, and the two side walls 141 jointly define an accommodating space 14A therebetween. Each of the two longitudinal structures 15 is disposed adjacent to one of the two auxiliary brackets 14, and each of the two longitudinal structures 15 has a longitudinal locking hole 151 that is a locking hole formed along a longitudinal direction (e.g., a Z-axis direction as shown in FIG. 21). Specifically, the operating component 21 of each of the two adjusting assemblies 2 is a screw, and the screw (i.e., the operating component 21) is locked in the longitudinal locking hole 151. Moreover, each of the two side walls 141 of any one of the two auxiliary brackets 14 has a pivoting hole 1411.

The switch module 100 further includes two pushing components 24, and a quantity of the pushing component 24 corresponds to a quantity of the auxiliary button A3 of the mouse A. Specifically, each of the two pushing components 24 is movably connected to the supporting structure 1, each of the two pushing components 24 has an abutting surface 243, and a shape of each of the two pushing components 24 can be approximately a structure that is trapezoidal.

Each of the two pushing components 24 includes a body 241 and two pivoting axes 242 disposed on one end of the body 241, and the two pivoting axes 242 are respectively arranged at two sides of the body 241. Specifically, the body 241 is pivotally connected to the pivoting hole 1411 of each of the two side walls 141 of one of the two auxiliary brackets 14 through the two pivoting axes 242, one end of the body 241 that is opposite to another end of the body 241 having the two pivoting axes 242 is disposed adjacent to a corresponding one of the two elastic plate bodies 32.

As shown in FIG. 21 to FIG. 23, two side surfaces of the abutting component 24 that are opposite to each other respectively have the abutting surface 243 and a pushing surface 244, the abutting surface 243 is adjacent to the screw (i.e., the operating component 21), and the pushing surface 244 is adjacent to one of the two elastic plate bodies 32. One end of the pushing surface 244 adjacent to the supporting structure 1 is defined as a bottom end 246, and another end of the pushing surface 244 away from the supporting structure 1 is defined as a top end 245.

As shown in FIG. 23, a transverse distance between the abutting surface 243 and the pushing surface 244 is gradually increased from the top end 245 of one of the two pushing components 24 to the bottom end 246 of the one of the two pushing components 24. Accordingly, when the screw (i.e., the operating component 21) is manipulated to move downward, the screw (i.e., the operating component 21) pushes the abutting surface 243 to move a corresponding one of the two pushing components 24 in a direction of a right side of the drawing (i.e., FIG. 23), so that the pushing surface 244 pushes a corresponding one of the two elastic plate bodies 32 to reduce the spacing G between the switch component 41 and the pressing structure A31.

Based on the above, the screw (i.e., the operating component 21) is movable along a longitudinal direction (e.g., a Z-axis direction as shown in FIG. 23) by being manipulated, each of the two auxiliary buttons A3 is approximately movable along a transverse direction (e.g., an X-axis direction as shown in FIG. 23) by being pressed, and the longitudinal direction is not parallel to the transverse direction. Accordingly, the screw (i.e., the operating component 21) can be easily manipulated by the assembler.

### [Beneficial Effects of the Embodiment]

In conclusion, in the mouse provided by the present disclosure, through a design of the switch module including the supporting structure, the two adjusting assemblies, the bottom plate, and the two micro switches, the assembler can adjust the spacing between the switch component of each of the two micro switches and the pressing structure by manipulating the operating component during a process of assembling the mouse. In this way, it can be ensured that, when the user purchases the mice of a same model, the two auxiliary buttons of each of the mice can have an approximately same tactile feedback when pressed.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A mouse, comprising:
a housing;
at least one auxiliary button movably disposed on one side of the housing, wherein an inner side of the at least one auxiliary button includes a pressing structure;
at least one switch module, including:
a supporting structure fixed to an inner side of the housing;
at least one adjusting assembly including an operating component, wherein the operating component is movably connected to the supporting structure;
a bottom plate connected to the supporting structure; and
at least one micro switch disposed on the bottom plate, wherein a switch component of the at least one micro switch faces toward the pressing structure;
wherein the operating component is movable relative to the supporting structure and drives the bottom plate by being manipulated, so as to change a spacing between the switch component and the pressing structure; and
a bottom base, wherein the bottom base is configured to carry a main circuit board, a motion detection module, and a processor disposed thereon, the bottom plate is a component that is independent from the main circuit board, and the at least one micro switch is electrically coupled to the processor through a flexible flat cable or a wire.

2. The mouse according to claim 1, wherein the operating component is a screw, the at least one adjusting assembly further includes a limiting component and an action component, the screw is disposed on the supporting structure, the limiting component is connected to the screw, and the limiting component is configured to prevent the screw from moving forward or backward along an axis direction relative to the supporting structure, wherein the screw is locked in a locking hole of the action component, and the bottom plate is connected to the action component, and wherein the screw is rotatable to drive the action component to move forward along the axis direction, and the action component is configured to drive the bottom plate to move in a direction toward the pressing structure, so as to change the spacing between the switch component and the pressing structure.

3. The mouse according to claim 1, wherein the bottom plate includes a body and two elastic plate bodies, the body has two penetrating holes, one end of each of the two elastic plate bodies is connected to an inner side of one of the two penetrating holes, another end of each of the two elastic plate bodies is a free end, and the at least one micro switch is disposed on one of the two elastic plate bodies, and wherein the operating component is configured to push one of the two elastic plate bodies by being manipulated, so as to enable the one of the two elastic plate bodies to be elastically deformed.

4. The mouse according to claim 3, wherein the at least one switch component further includes an elastic arm, one end of the elastic arm is connected to the supporting structure, the elastic arm is obliquely disposed in a direction toward the bottom plate, and another end of the elastic arm is a free end, wherein the supporting structure has a locking hole, the operating component is a screw, and the locking hole faces toward the free end of the elastic arm, and wherein an end of the screw is configured to press the elastic arm by manipulating the screw, so that the free end of the elastic arm pushes the elastic plate body adjacent thereto to change the spacing.

5. The mouse according to claim 4, wherein the elastic arm includes an abutting portion, the abutting portion faces toward the locking hole, and the abutting portion is provided for the end of the screw to push thereagainst.

6. The mouse according to claim 4, wherein the at least one auxiliary button is movable along a transverse direction by being pressed, the screw is movable along a longitudinal direction relative to the supporting structure by being manipulated, and the longitudinal direction is not parallel to the transverse direction.

7. The mouse according to claim 2, wherein the at least one switch module further includes a pushing component movably connected to the supporting structure, the pushing component has an abutting surface, the supporting structure further includes a locking hole, and the operating component is a screw locked in the locking hole, and wherein the screw is configured to push the abutting surface by being manipulated to enable the pushing component to push one of the two elastic plate bodies adjacent thereto, so as to adjust the spacing.

8. The mouse according to claim 7, wherein the pushing component includes a body and two pivoting axes, the two pivoting axes are disposed on one end of the body of the pushing component, and the two pivoting axes are respectively arranged at two sides of the body of the pushing component, and wherein the body is pivotally connected to the supporting structure through the two pivoting axes, and another end of the body that is opposite to the one end of the body having the two pivoting axes is arranged adjacent to one of the two elastic plate bodies.

9. The mouse according to claim 7, wherein one end of the pushing component adjacent to the supporting structure is defined as a bottom end, another end of the pushing component away from the supporting structure is defined as a top end, and two side surfaces of the pushing component opposite to each other are respectively the abutting surface and a pushing surface, and wherein the pushing surface is configured to push one of the two elastic plate bodies, and a transverse distance between the abutting surface and the pushing surface is gradually increased from the top end to the bottom end.

10. The mouse according to claim 7, wherein the at least one auxiliary button is movable along a transverse direction by being pressed, the screw is movable along a longitudinal direction relative to the supporting structure by being manipulated, and the longitudinal direction is not parallel to the transverse direction.
